(19) United States
(12) Patent Application Publication
(10) Pub. No.: US 2005/0227126 A1
(43) Pub. Date: Oct. 13, 2005

(54) Method and apparatus for cold-starting a PEM fuel cell (PEMFC), and PEM fuel cell system

(75) Inventors: Konstantin Korytnikov, Fort Lauderdale, FL (US); Peter Novak, Fort Lauderdale, FL (US)

Correspondence Address: LERNER AND GREENBERG, PA, P O BOX 2480, HOLLYWOOD, FL, 33022-2480, US

(73) Assignee: Ener1, Inc.

(21) Appl. No.: 11/101,903

(22) Filed: Apr. 8, 2005

Related U.S. Application Data
(60) Provisional application No. 60/560,836, filed on Apr. 8, 2004.

(51) Int. Cl. H01M 8/04; H01M 8/10

(52) U.S. Cl. 429/13; 429/30; 429/26

(57) ABSTRACT

A low temperature proton exchange membrane fuel cell (PEMFC) system can be efficiently started even when the system is at a temperature near or below freezing (0° C). The cold start procedure is accomplished through heating the fuel cell by filling an anode chamber with fuel (hydrogen or hydrogen-rich reactant gas) and generating hydrogen on a cathode. A defined amount of oxygen is supplied to the cathode chamber. The fuel cell system is locally heated up to defined temperature by the exothermic chemical reaction between hydrogen and oxygen on a cathode catalyst. Then the hydrogen generation on the cathode is canceled and oxygen is supplied to the cathode chamber in an amount sufficient to maintain the current flowing through an external load. This procedure provides plain saturation of the cathode with hydrogen and, as result, mild, safe and fast heating the fuel cell without use of additional external devices.

### CROSS-REFERENCE TO RELATED APPLICATION

This non-provisional application claims the benefit, under 35 U.S.C. § 119(e), of provisional application No. 60/560,836, filed Apr. 8, 2004.

### BACKGROUND OF THE INVENTION

### Field of the Invention

The present invention lies in the field of fuel cell technology. More specifically, the invention pertains to a method and a system for rapidly initiating proper operation of a fuel cell or fuel cell powered machine and, more particularly, to methods and apparatus for starting up and operating fuel cell systems at subfreezing temperatures.

Fuel cells generate electrical power that can be used in a variety of applications. Fuel cells constructed with proton exchange membranes (PEM, also referred to as polymer electrolyte membranes) may eventually replace the internal combustion engine in motor vehicles. PEM fuel cells have an ion exchange membrane, partially comprised of a solid electrolyte, affixed between an anode and a cathode. To produce electricity through an electrochemical reaction, hydrogen is supplied to the anode and air is supplied to the cathode. An electrochemical reaction between the hydrogen and the oxygen in the air produces an electrical current, with water as a reaction product and heat. The water is removed from the cathode.

The ion exchange membrane commonly used in PEM fuel cells is partially comprised of a sulfonated chemical compound that binds water in the membrane in order to ensure sufficient proton conductivity. At ambient temperatures below 1° C., water contained in the membrane can freeze. When such freezing occurs, the electrical resistance of the membrane may increase by two to three orders of magnitude.

Conventional fuel cells currently known in practice can only produce current at temperatures above a defined starting temperature, which, at this time, lies approximately at 5° C. In the event of a cold start (i.e. temperatures at or below approximately 5° C.), a fuel cell must first be heated to temperatures that are above the starting temperature. Because of the considerable thermal mass of the fuel cells, the needed increase in temperature requires a considerable amount of heat energy. Power required to effect starting can be large if the cold start is to take place within times similar to those achieved in conventional internal combustion engines.

Considerable efforts have been and are being directed toward processes designed to accelerate the rate at which a PEM fuel cell system can be heated up to above-freezing temperatures.

It has become known from the prior art, for instance, that the introduction of an H₂/air mixture into the fuel cell stack can be used to initiate an exothermic chemical reaction within the fuel cell stack. U.S. Pat. No. 6,127,056, by way of example, describes a process in which a fuel cell is warmed to operating temperature during start-up by introducing a small amount of hydrogen into a flow of air to an air inlet of the fuel cell. There, the hydrogen and the oxygen react at the catalyst surface to produce heat. It is a drawback of that prior art process that warmed substance is remote from the cathode where typical electrochemical reaction occurs. In a process disclosed in U.S. Pat. No. 6,103,410, an H₂/air mixture is delivered into oxidant channels and reacts on a catalyst disposed in hydrophobic regions of the cathode.

U.S. Pat. No. 6,358,638 teaches a method in which the membrane electrode assembly (MEA) is locally heated from below freezing to a suitable operating temperature by the exothermic reaction between H₂ and O₂ on the anode and/or cathode catalysts. Hydrogen is introduced into the O₂-rich cathode feed stream and/or O₂ is introduced into the H₂ -rich anode feed stream. It is a considerable disadvantage in the processes of the prior art patents U.S. Pat. Nos. 6,103,410 and 6,358,638 that a heated zone is mainly restricted to electrode area adjacent to the gas channel entry. That eventually causes damage to such PEM components.

In all the above-mentioned systems, it is necessary to provide an auxiliary apparatus for gas mixture preparation.

In another approach—described in published U.S. patent application U.S. 2004/0013915 A1, a PEM fuel cell is heated from a temperature below freezing (0° C.) by supplying hydrogen to an anode so as to form water by combining with oxygen generated at the anode by the electrolysis of the frozen water. Further, oxygen is supplied to a cathode so as to form water by combining with hydrogen generated at the cathode by the electrolysis of the frozen water. The application of that concept relies on sufficient power diverted from a secondary battery (at a temperature of −30° C., it is necessary to apply a voltage of 2.4 V to each fuel cell). Meanwhile, of course, the secondary battery itself has very low performance characteristics at sub-freezing temperatures. A plot of the oxygen generation on the anode indicates that that prior art configuration requires more significant noble metal loading in an anode catalyst than is used in modern fuel cells.

### SUMMARY OF THE INVENTION

It is accordingly an object of the invention to provide a method and a system for rapidly initiating proper operation of a PEM fuel cell or fuel cell stack at subfreezing temperatures which overcomes the above-mentioned disadvantages of the heretofore-known devices and methods of this general type and which enables starting such PEM fuel cell systems at sub-freezing temperature without the use of external heating means and auxiliary apparatus.

With the foregoing and other objects in view there is provided, in accordance with the invention, a method for heating up a PEM fuel cell system from a sub-freezing temperature to a higher temperature required for self-sustaining operation of the fuel cell. The fuel cell system has a PEM fuel cell or a stack of fuel cells each with a proton-exchange membrane between a cathode and an anode, and an external electrical circuit connected to the anode and the cathode. The method comprises the following steps:

supplying hydrogen to the anode and dissociating the hydrogen at the anode into hydrogen ions and electrons;

causing the hydrogen ions to pass from the anode through the proton-exchange membrane to the cathode, conducting the electrons through the external electrical circuit to the cathode, and driving an exothermic reaction at the cathode by combining the hydrogen ions with the electrons to generate hydrogen and combining the hydrogen with oxygen to generate water.

In accordance with an advantageous mode of the invention, the above-mentioned dissociating step is driven so as to avoid any substantial electrolysis of water. Instead of the electrolysis, the invention makes use of the so-called hydrogen pump effect.

In other words, the present invention deals with a method of heating up a PEM fuel cell system from sub-freezing temperatures when fuel cell system self-sustaining operation is limited due to low temperatures. The fuel cell system includes at least one fuel cell for production of the electrical power. Typically, of course, there are provided several fuel cells in one or more fuel cell stacks that are electrically connected so as to provide for the necessary voltage and power for the specific application. The stacks are also mechanically and fluidically connected so as to properly share in the fuel and oxidant supplies, as well as in the cooling system.

Each fuel cell includes a membrane-electrode-assembly (MEA) combining a proton-exchange membrane, a cathode electrode (hereinafter, cathode, also referred to as a hydrogen electrode) and an anode electrode (hereinafter, anode, also referred to as an oxygen or air electrode) disposed on opposite sides of the membrane. An external circuit is connected to the anode and cathode for conducting the electrical current generated by the fuel cell, and a primary load is connected through a primary load switch to the external circuit. Either an auxiliary load is connected through an auxiliary load switch to the external circuit, or a power supply Is connected through a power supply switch to the external circuit.

The present invention utilizes the hydrogen pump effect wherein hydrogen dissociates at the anode into electrons and hydrogen ions, the hydrogen ions pass through the electrolyte to the cathode as in normal fuel cell operation, and the electrons flow to the cathode to evolve hydrogen at the cathode. In the first embodiment, such a hydrogen pump effect is achieved by a suitable power supply such as a back-up battery. Current from the battery is applied to the external electrical circuit, first, in the presence of hydrogen on the anode catalyst in sufficient amount and, second, under control of the fuel cell voltage at a level below approx. −0.4 volts per cell to prevent water electrolysis, and, consequently, oxygen generation on the anode catalyst. According to our calculations, this “reverse” voltage should be maintained safely at or below the indicated level because at or above −0.15 V the avoidance of water electrolysis cannot be assured.

In a second embodiment, the hydrogen pump effect is achieved by an auxiliary load, for example an internal electrical heater that is connected to the external electrical circuit. This is, first, done in the presence of hydrogen on the anode catalyst in an amount that exceeds the stoichiometric rate for electrochemical hydrogen oxidation related to the electrical current flowing through the external electrical circuit. Secondly it is done in the presence of oxygen on the cathode catalyst in amount that is at the stoichiometric rate for chemical reaction with hydrogen evolving on the cathode catalyst. In this embodiment the hydrogen pump is driven due to the fuel cell voltage dictated by the difference in hydrogen partial pressure between the anode and the cathode in accordance with the Nernst equation.

In a further embodiment the hydrogen pump effect is achieved by an auxiliary load that is used in the event of a temperature decrease to above-freezing temperature to prevent water freezing in the cell, and, consequently, damage to the fuel cell structure caused by the volume expansion when water undergoes a phase change from the liquid phase to the solid phase (ice).

The exothermic chemical reaction on the cathode catalyst between evolving hydrogen and oxygen delivered by means of an air compressor causes warming up the fuel cell system up to defined temperature, after which the fuel cell system itself is able to carry the primary load.

The novel method and apparatus according to the invention may be further summarized as follows: the fuel cell system apparatus has at least one fuel cell, having a membrane electrode assembly comprising a proton-exchange membrane, a cathode catalyst coated on a first side and an anode catalyst coated on a second side of the membrane; an external electrical circuit connected to the anode and cathodes, an external circuit for conducting electricity to load, a primary load connected through a primary load switch to the external circuit, and a power supply connected through a power supply switch to the external circuit. The method comprising at least the following steps:

supplying hydrogen to the anode catalyst;

connecting the power supply through the power supply switch to an external circuit so that electrical current from the power supply flows through the external circuit to the anode and cathode electrodes to consume hydrogen on the anode catalyst and to generate hydrogen on the cathode catalyst;

maintaining the fuel cell voltage applied to the fuel cell system apparatus from the power supply, such that the fuel cell voltage does not drop below approximately −0.4 volts per cell to prevent the generation of oxygen on the catalyst of the anode;

providing air to the cathode catalyst for exothermic combination reaction (between oxygen and hydrogen) at the cathode catalyst;

disconnecting the power supply by means of the power supply switch from the external circuit at the pre-defined temperature of the fuel cell self-sustaining operation; and

connecting the primary load by means of the primary load switch to the external circuit.

In accordance with an advantageous feature of the invention, the power supply is connected into the external circuit so that electrical current from the power supply flows through the external circuit to the anode and cathode electrodes to consume hydrogen on the anode catalyst and to generate hydrogen on the cathode catalyst, and the power supply is disconnected from the external circuit at a defined value of the electrical current flowing through the external circuit

As indicated above, the voltage from the secondary battery is applied to the fuel cell in “reverse” polarity. That is, a positive battery terminal is connected to the anode of the fuel cell, and the negative battery terminal is connected to the cathode. In this case the battery forces electrons to flow from the fuel cell anode to the cathode. But in such commutation of the two power sources, the battery and the fuel cell work against each other because it is a parallel connection wherein “minus” of one power supply is connected to a “plus”. If no gases are supplied to the fuel cell, the oxygen evolves on the anode in H₂O→½O₂+2e⁻+2H⁺ (electrons are taken from the anode and protons are pushed across the membrane) and the hydrogen is going to evolve on the cathode. According to the invention, then, we force the fuel cell anode (“minus”) to serve as a positive pole and the cathode to serve as a negative pole. The voltage of the fuel cell is inversed. Providing electrolysis in such direction would require a voltage value of −1.55V or more. But the major contribution in a value of the voltage is polarization for the reaction, which occurs on the anode. If the hydrogen is kept in the anode chamber one can initiate proton flow across the membrane at −0.1V because the polarization of H₂⇄2H⁺+2e⁻ is very small. But if one gradually increases the applied current acceleration of hydrogen removal from the anode to the cathode increases dramatically. At certain point, due to the limitation of hydrogen supply to the anode a reaction of hydrogen oxidation is changed by the reaction of oxygen reduction followed by the voltage jump to −1.55V. To prevent such a scenario we limit the applied voltage to −0.4V. At such a value the oxygen generation is prevented.

In a preferred implementation of the invention we also supply air to the cathode. It makes possible for the fuel cell to generate its own voltage (which is positive). At first stage the frozen fuel cell is so “weak” and it cannot resist the negative voltage applied from a battery. But the very small negative voltage is enough. Due to the internal heating, however, the fuel cell gathers “strength” and higher current and, consequently, more negative voltage from the battery is required to compete with the fuel cell. Accordingly, we have chosen −0.4V for ending because at that point, the fuel cell can operate by itself and, also, the secondary battery is not able to compete with the fuel cell.

In an alternative embodiment, the apparatus is provided with an auxiliary load (instead of, or in addition to, the auxiliary power supply) that can be connected into the external circuit through an auxiliary load switch (e.g., a further switch in addition to the primary load switch). The method of the second embodiment comprises the following steps:

supplying hydrogen to the anode catalyst;

connecting the auxiliary load by means of the auxiliary load switch to the external circuit so that electrical current flows through the external circuit to the anode and cathode to consume hydrogen on the anode catalyst so as to generate hydrogen on the cathode catalyst;

providing oxygen to the cathode catalyst, maintaining the air flow rate through the cathode catalyst, so that the fuel cell voltage does not exceed 0.2 volts per cell so as to prevent changing electrochemical reaction of hydrogen generation with electrochemical reaction of oxygen reduction on the cathode catalyst;

disconnecting the auxiliary load by means of the auxiliary load switch from the external circuit at or above the pre-defined temperature of self-sustaining operation;

connecting the primary load by means of the primary load switch to the external circuit.

Once more in summary, the novel method utilizes the hydrogen pump effect wherein hydrogen dissociates at the anode into electrons and hydrogen ions, the hydrogen ions pass through the electrolyte to the cathode as in normal fuel cell operation, and the electrons flow to the cathode to evolve hydrogen at the cathode. The hydrogen pump can be driven either by the back up battery application or by the fuel cell voltage dictated by the difference in hydrogen partial pressure between the anode and the cathode chambers in accordance with the Nemst equation:
ΔV=(RT/2F)In(P_{H anode}/P_{H cathode})

The exothermic chemical reaction on the cathode catalyst between evolving hydrogen and oxygen delivered by means of an air compressor causes warming up the fuel cell system up to defined temperature, after which the fuel cell system itself is able to carry the primary load.

Primary advantages of the invention include the fact that plain saturation of all electrocatalyst is achieved and, as result, mild, even, and safe heating of the entire cathode surface. Also, fast ice melting in the cathode where the exothermic chemical reaction takes place, and quick heating of the fuel cell to the self-sustaining operating temperature (in 40-50 seconds).

When the backup or auxiliary battery is connected to the fuel cell, hydrogen is consumed at the anode and generated at the cathode. The fuel cell voltage applied to the fuel cell is maintained at level of −0.4 V per cell to prevent the generation of oxygen on the anode. Delivering oxygen to the cathode by means of opening the cathode inlet valve, the cathode inlet valve and turning on the air compressor. The airflow rate generated by the air compressor is adjusted to a rate of the hydrogen generation on the cathode, and, consequently, to the electrical current flowing through the fuel cell. This is in order to keep hydrogen concentration in air at the cathode less than 4% for safety reason.

the primary load may be connected to the fuel cell and self-heating may continue under the typical electrochemical reactions. Optionally, the defined voltage may be achieved by increasing the value of the primary load. Subsequently, the regular power operation may begin at full power of the fuel cell system.

Other features which are considered as characteristic for the invention are set forth in the appended claims.

Although the invention is illustrated and described herein as embodied in a method and an apparatus for cold-starting a PEMFC system, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawing.

### BRIEF DESCRIPTION OF THE DRAWING FIGURES

FIG. 1 is a schematic view of a fuel cell system that may be started up in accordance with a first mode of the method of the present invention;

FIG. 2 is a schematic view of a fuel cell system that may be started up in accordance with a second mode of the method of the present invention;

FIGS. 3A, 3B, and 3C are timing charts showing a variation of a fuel cell voltage, temperature, and electrical current during starting in accordance with embodiment variations 1 and 3, and the system illustrated in FIG. 1; and

FIGS. 4A, 4B, and 4C are timing charts showing a variation of a fuel cell voltage, temperature, and electrical current during starting in accordance with embodiment variations 2 and 4, and the system illustrated in FIG. 2.

### DESCRIPTION OF THE PREFERRED EMBODIMENTS

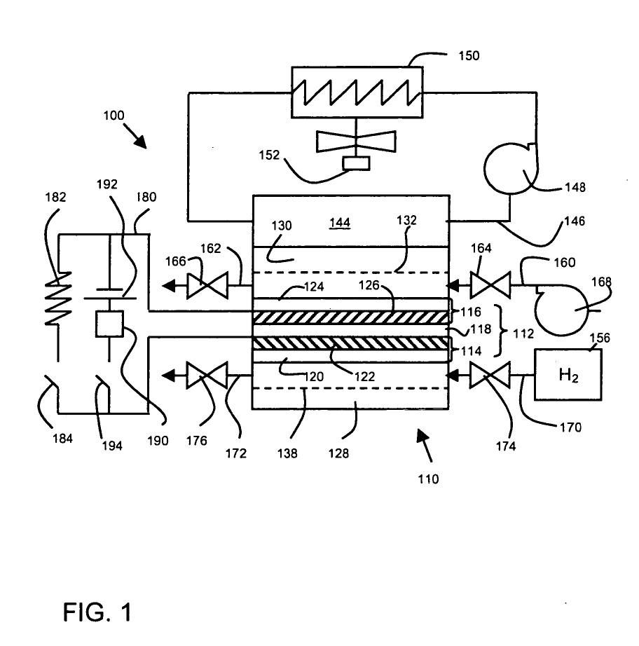

Referring now to the figures of the drawing in detail and first, particularly, to FIG. 1 thereof, there is shown a first embodiment of an apparatus and a corresponding method for cold-starting a PEM fuel cell system. The system and cold-start apparatus is generally designated by the reference numeral 100. The system includes a fuel cell 112 having an anode 114, a cathode 116, and a proton exchange membrane (PEM, also referred to as a polymer electrolyte membrane) 118 disposed between the anode and cathode.

The anode 114, which may also be referred to as a hydrogen electrode, includes an anode diffusion substrate 120 and an anode catalyst layer 122 disposed thereon on the side of the substrate 120 facing the PEM 118. The cathode 116, which may also be referred to as an oxygen electrode, includes a cathode diffusion substrate 124, having a cathode catalyst layer 126 disposed thereon facing the PEM 118. The cell also includes an anode flow field 128 adjacent the anode diffusion substrate 120 and a cathode flow field 130 adjacent the cathode diffusion substrate 124.

In operation, the anode 114 conducts electrons that are split off from the hydrogen and the electrons from the anode flow into an external circuit to produce the electromotive force (emf) forming the useful output of the fuel cell. The electrons, after flowing through the external circuit and to the cathode, are once more recombined with the hydrogen ions and with oxygen on the cathode side, where water is formed. The chemical reactions are as follows:

| | |
|---|---|
| Anode: | 2H₂ → 4H⁺ + 4e⁻ |
| Cathode: | O₂ + 4H⁺ + 4e⁻ → 2H₂O |
| Net Reaction: | 2H₂ + O₂ → 2H₂O |

The proton exchange membrane (PEM) is an electrolyte which allows the hydrogen ions H⁺ to pass through, but it blocks electrons. The catalyst is formed to catalyze the reaction of H and O. The PEM fuel cell (PEMFC) operates at relatively low temperatures (˜80° C., 175° F.), hence the designation “low temperature fuel cell.”

The cathode flow field 130 comprises a plurality of channels 132 extending through the cathode flow field 130 for carrying an oxidant, preferably air, across the cathode from a cathode inlet 134 to a cathode outlet 136. Similarly, the anode flow field 128 comprises a plurality of channels 138 extending through the anode flow field 128 for carrying hydrogen across the anode 114 from an anode inlet 140 to an anode outlet 142. The anode flow field 128 and the cathode flow field 130 include pores, channels, or voids defined within the anode and cathode flow fields 128, 130 to direct the reactant streams passing through the fields 128, 130 to pass adjacent to and In contact with the anode 114 or cathode 116.

Each fuel cell 112 may also include a water transport plate or cooler plate 144 adjacent to the cathode flow field plate 130 for removing heat and for removing product water from the fuel cell 112. The coolant transport plate 144 is secured in fluid contact with a coolant loop 146 having a coolant pump 148 for circulating a cooling fluid, such as water or glycol, through the coolant loop 146 and the plate 144. A heat exchange radiator 150 and a fan 152, which may be similar to a standard automotive radiator and fan assembly, are also affixed in heat exchange relationship with the coolant loop 146.

Only one fuel cell 112 is illustrated for simplicity of the illustration. It will be understood that a system for powering loads, such as motor vehicles, is operated with one or more fuel cell stacks in which fuel cells—which each generate a voltage of approximately 0.7 V—are disposed in a stacked relationship and electrically connected so as to provide the required potential and attendant power. A typical stack of fuel cells has a plurality of adjacent cells electrically connected in series, each having a cooler plate 144 or separator plate separating the cathode flow field of one cell from an anode flow field of the adjacent cell.

The fuel cell system includes a fuel source 156 and an oxygen source 158, such as air. The fuel may be substantially pure hydrogen or other hydrogen rich fuel. For example, the hydrogen H₂ may originate from a reformer, which converts hydrocarbon fuels or alcohol fuels into oxygen. A cathode inlet line 160 carries air from the source 158 into the cathode flow field inlet 130; and a cathode exhaust line 162 carries spent air away from the cathode outlet 136. A cathode inlet valve 164 is secured to the cathode inlet line 160, and a cathode outlet valve 166 is secured to the cathode exhaust line 162 for permitting and terminating flow of the process oxidant or air through the cathode flow field 130. An air compressor 168 is connected to the cathode inlet line 160 to increase a pressure of the air stream passing through the cathode flow field 130.

An anode inlet line 170 connects the fuel source 156 with the anode flow field 128. An anode exhaust line 172 directs the hydrogen stream out of the anode flow field 128. An anode inlet valve 174 is secured to the anode inlet line 170, and an anode exhaust valve 176 is secured to the anode exhaust line 172, for permitting or terminating flow of the hydrogen through the anode flow field 128.

The fuel cell power plant or fuel cell system 110 also includes an external electric circuit 180 connecting the anode 114 and the cathode 116. The external circuit 180 as illustrated has a primary load 182 connected through a primary load switch 184. A power supply 192 is also connected to the external circuit 180 through a power supply switch 194. A controller 190 controls a value of the voltage applied to the fuel cell system if the power supply switch 194 is closed.

During normal operation of the fuel cell system 110, the primary load switch 184 is closed, and the power supply switch 194 is open, so that the fuel cell system is providing electricity to the primary load, such as an electric motor, an accumulator, a battery bank, or the like. The air compressor 168 and the coolant pump 148 are all on (operating). The cathode inlet and exhaust valves 164 and 166 are open, as are the anode inlet 174 and anode exhaust valves 176.

During storage of the fuel cell system 110, the primary load switch 184 and the power supply switch 194 are open. The air compressor 168 and the coolant pump 148 are all off. The cathode inlet and exhaust valves 164 and 166, the anode inlet 174 and anode exhaust valves 176 are closed.

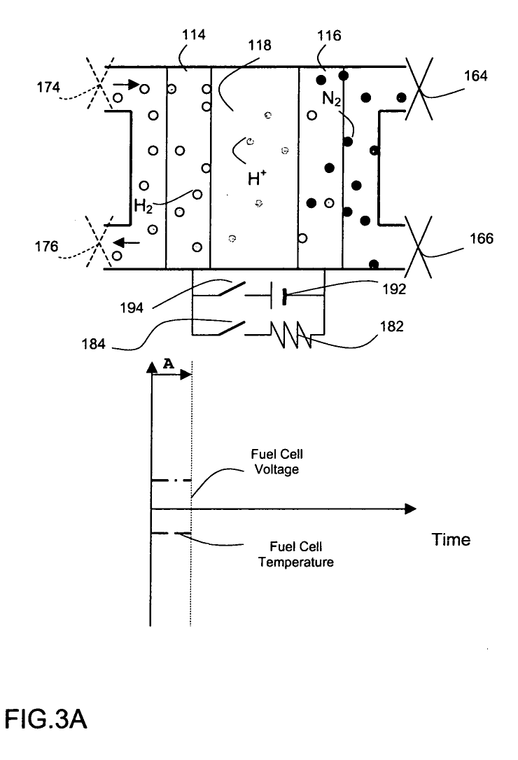

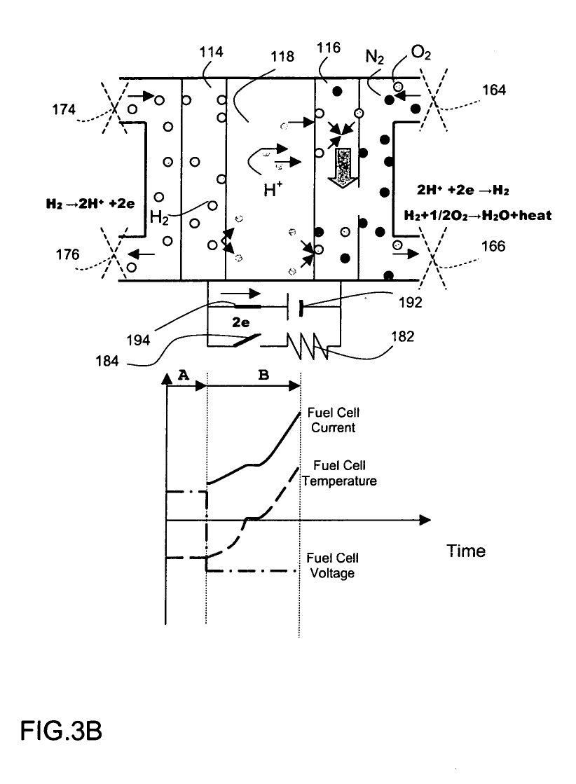

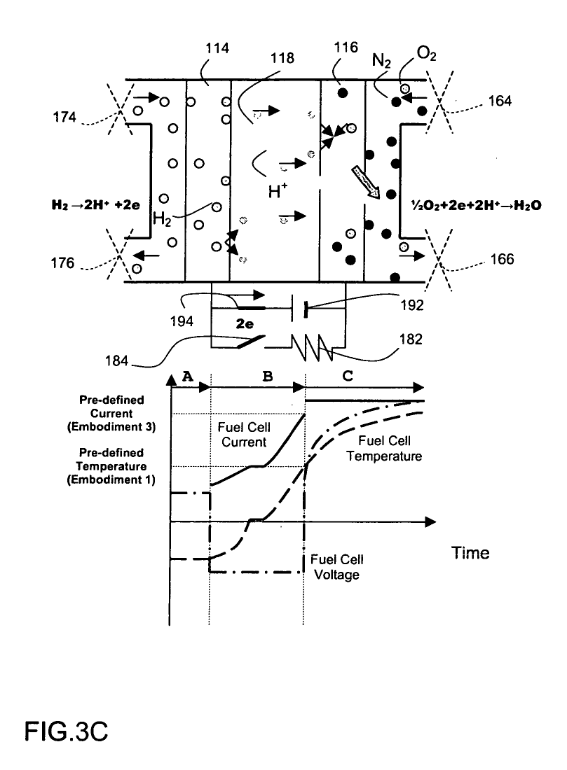

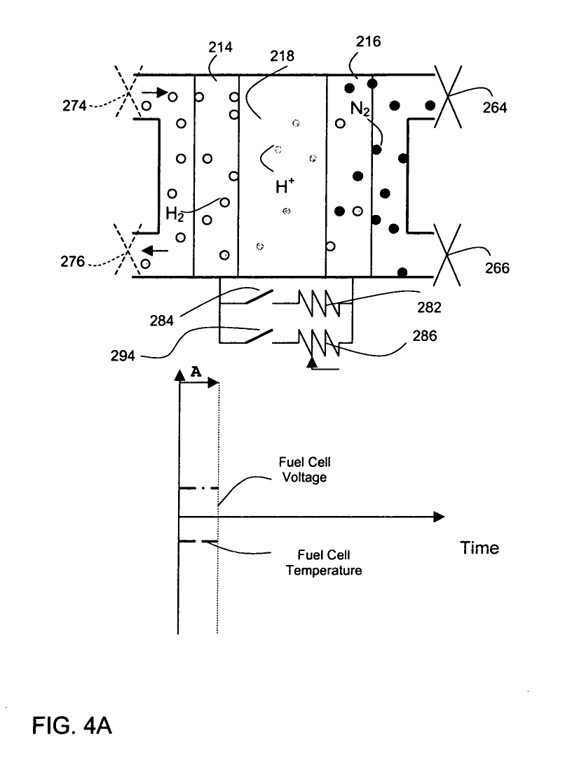

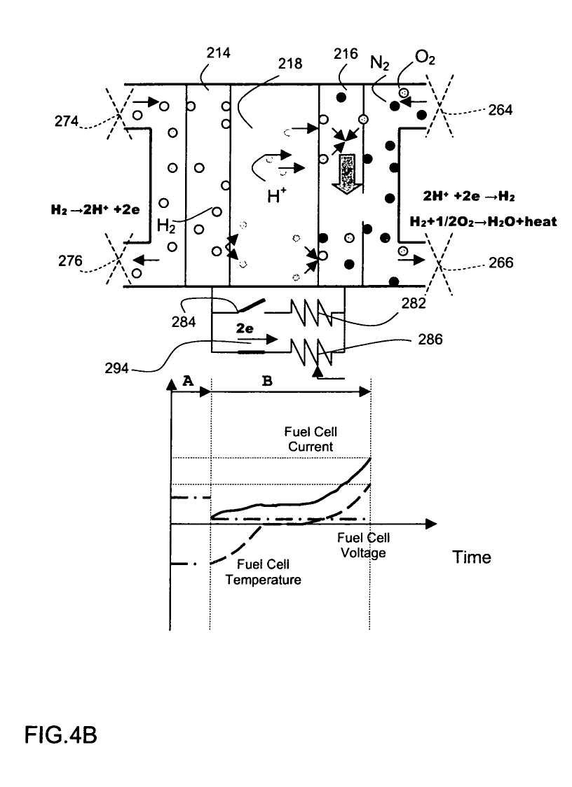

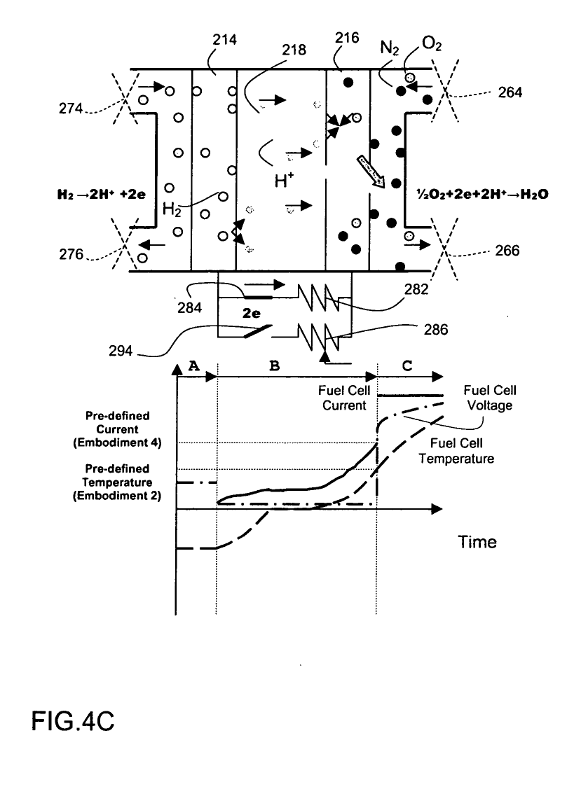

The method for starting up the fuel cell system 110 according to this embodiment of the present invention includes opening the anode inlet valve 174 and the anode exhaust valve 176 so as to introduce the flow of fresh hydrogen-rich fuel to the anode. The anode exhaust valve 176 may remain closed if the fuel is pure hydrogen. The open valves are indicated in FIG. 3A by dashed lines, while the closed valves are indicated by solid lines.

The power supply 192 is connected to the external circuit by closing the power supply switch 194. With current flowing through the external circuit 180, hydrogen dissociates at the anode electrode into electrons and hydrogen ions, the hydrogen ions pass through the electrolyte to the cathode 116 where hydrogen appears at the cathode 116. To avoid changing a desirable electrochemical reaction of hydrogen oxidation by electrolysis of water on the cathode 116, the fuel cell voltage is limited to about −0.4 V per cell by the controller 190.

Opening the cathode inlet valve 164, the cathode exhaust valve 166 (see FIG. 3B) and running the air compressor 168 introduces oxygen to the cathode 116 to maintain the exothermic chemical reaction between evolving hydrogen and delivered oxygen on the cathode 116. The airflow rate generated by the air compressor 168 is adjusted to a rate of hydrogen generation on the cathode 116, and, consequently, to the electrical current flowing through the external circuit 180.

Turning on the coolant pump 148 initiates circulating the coolant fluid. The fan 152 may remain off to prevent the loss of heat and power diverted from the power supply 192. The operation of the coolant loop is subject to temperature and efficiency considerations as defined by simple thermostat control or by the fuel system controller.

At a defined temperature when the fuel cell system is able to operate the primary load 182 the power supply 192 is disconnected from the external circuit 180 through the power supply switch 194, and, the primary load 182 is connected to the external circuit 180 through the primary load switch 184. The air compressor 168 delivers air at a rate that is determined by the stoichiometric requirement for normal operation of the fuel cell system 110.

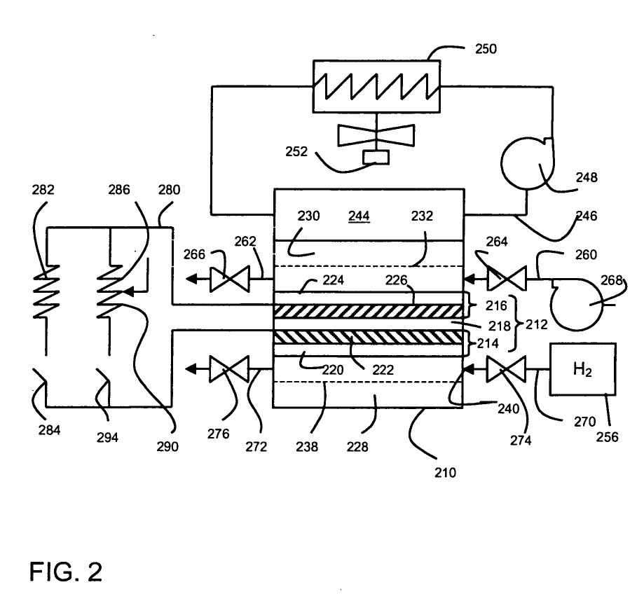

FIG. 2 illustrates a second embodiment of the invention. Corresponding elements and features of the system are referenced with corresponding numerals, with the elements in FIG. 1 using the 100 range and the elements in FIG. 2 using the 200 range.

In the heating phase, the fuel cell voltage is limited to about 0.2 V per cell by a regulated auxiliary load 290 connected to the external circuit 280 through a auxiliary load switch 294. The air flow rate generated by the air compressor 268 is adjusted to a rate of hydrogen generation on the cathode 216, and, consequently, to the electrical current flowing through the external circuit 280. This is in order to keep oxygen concentration in the proper stoichiometric ratio to hydrogen concentration on the cathode 216.

In a third mode of the invention, the power supply 192 is disconnected from the external circuit 180 through the power supply switch 194, and, the primary load 182 is connected to the external circuit 180 through the primary load switch 184 in the event of an increase in the electrical current flowing through the external circuit 180 up to a defined value that represents sufficient fuel cell warming for the normal fuel cell system operation.

In a fourth mode of the invention, the regulated auxiliary load 290 is disconnected from the external circuit 280 through the auxiliary load switch 294, and, the primary load 282 is connected to the external circuit 280 through the primary load switch 284 in the event of an increase in the electrical current flowing through the external circuit 280 up to a defined value that shows that the fuel cell is sufficiently warmed up for normal fuel cell system operation.

In a fifth mode of the invention, the regulated auxiliary load 290 is connected to the external circuit 280 through the auxiliary load switch 294 at above-freezing temperature to prevent that water may freeze in the cell. The load 290 is disconnected from the external circuit 280 through the auxiliary load switch 294 in event of an increase in the fuel cell temperature up to a defined value.

1. A method for heating up a PEM fuel cell system from a sub-freezing temperature to a higher temperature required for self-sustaining operation of the fuel cell, the fuel cell system having at least one PEM fuel cell with a proton-exchange membrane between a cathode and an anode, and an external electrical circuit connected to the anode and the cathode, the method which comprises the following steps:
supplying hydrogen to the anode and dissociating the hydrogen at the anode into hydrogen ions and electrons;
causing the hydrogen ions to pass from the anode through the proton-exchange membrane to the cathode, conducting the electrons through the external electrical circuit to the cathode, and driving an exothermic reaction at the cathode by combining the hydrogen ions with the electrons to generate hydrogen and combining the hydrogen with oxygen to generate water.

2. The method according to claim 1, which comprises substantially avoiding electrolysis of water in the dissociating step.

3. The method according to claim 1, which comprises connecting a secondary power supply into the external electrical circuit and maintaining a fuel cell voltage between the anode and the cathode at a value of below approximately −0.4 volts to substantially prevent an electrolysis of water and an attendant generation of oxygen at the anode.

4. The method according to claim 3, which comprises disconnecting the power supply from the external circuit when the temperature required for self-sustaining operation of the fuel cell has been attained.

5. The method according to claim 1, which comprises connecting an auxiliary load into the external electrical circuit, maintaining a hydrogen supply at the anode in an amount exceeding a stoichiometric rate for electrochemical hydrogen oxidation relative to an electrical current flowing through the external electrical circuit, and maintaining an oxygen supply at the cathode in an amount substantially at a stoichiometric rate for chemical reaction with hydrogen evolving at the cathode.

6. The method according to claim 5, wherein the auxiliary load is an internal electrical heater connected to the external electrical circuit.

7. The method according to claim 5, which comprises driving a hydrogen pump effect due to a fuel cell voltage dictated by a difference in hydrogen partial pressure between the anode and the cathode as defined by the Nernst equation.

8. A PEM fuel cell system, comprising:
at least one PEM fuel cell having a membrane electrode assembly (MEA) with a proton-exchange membrane, a cathode with a cathode catalyst, and an anode with an anode catalyst; and
a hydrogen supply for supplying hydrogen to said anode catalyst;
an air supply for supplying oxygen to said cathode catalyst;
a device for heating said fuel cell from a sub-freezing temperature to a temperature required for self-sustaining operation of said fuel cell, said device including an external electrical circuit connected to said anode and said cathode and a switch for connecting a power supply or an auxiliary load between said cathode and said anode, said device being configured to drive a hydrogen pump effect and substantially avoiding an electrolysis of water at said anode, and to drive an exothermic combination reaction at said cathode for heating said fuel cell to the temperature required for the self-sustaining operation of said fuel cell.

9. The device according to claim 8, which comprises a power supply selectively connectable into said external electrical circuit with reverse polarity and at a voltage substantially below −1.5 V.

10. The device according to claim 9, wherein said power supply is configured to maintain a fuel cell voltage at or below approximately −0.4 volts during a cold-start phase.

11. The device according to claim 8, wherein said power supply is disconnected from said external circuit when the temperature required for self-sustaining operation of the fuel cell is attained, and a primary load is connected to said fuel cell.

12. A method for heating up a PEM fuel cell system from a sub-freezing temperature to a temperature required for self-sustaining operation of the fuel cell, the method which comprises:
providing a fuel cell system with:
at least one PEM fuel cell having a membrane electrode assembly (MEA) with a proton-exchange membrane, a cathode with a cathode catalyst, and an anode with an anode catalyst; and
an electrical circuit connected to the anode and the cathode and a primary load switch for selectively connecting a primary load, and a power supply connected through a power supply switch to the cathode and the anode;
supplying hydrogen to the anode catalyst;
connecting the power supply into the electrical circuit through the power supply switch at a reverse polarity between the anode and the cathode and causing hydrogen to be consumed at the anode catalyst and hydrogen to be generated at the cathode catalyst;
maintaining a fuel cell voltage at no more than approximately -0.4 volts per fuel cell to substantially prevent a generation of oxygen at the anode catalyst;
supplying oxygen to the cathode catalyst for driving an exothermic reaction with the hydrogen at the cathode catalyst; and
disconnecting the power supply from the external circuit when the temperature required for self-sustaining operation of the fuel cell is attained.

13. The method according to claim 12, which further comprises connecting the primary load into the external circuit through the primary load switch when the temperature required for the self-sustaining operation of the fuel cell is attained.

14. A method for heating up a PEM fuel cell system from a sub-freezing temperature to a temperature required for self-sustaining operation of the fuel cell, the method which comprises:
providing a fuel cell system with:
at least one PEM fuel cell having a membrane electrode assembly (MEA) with a proton-exchange membrane, a cathode with a cathode catalyst, and an anode with an anode catalyst; and
an electrical circuit connected to the anode and the cathode and a primary load switch for selectively connecting a primary load, and an auxiliary load connected through a further switch to the cathode and the anode;
supplying hydrogen to the anode catalyst in an amount exceeding a stoichiometric rate for electrochemical hydrogen oxidation relative to an electrical current flowing through the external electrical circuit;
connecting the auxiliary load into the electrical circuit through the further switch and causing hydrogen to be consumed at the anode catalyst and hydrogen to be generated at the cathode catalyst; and
supplying oxygen to the cathode catalyst in an amount substantially at a stoichiometric rate for chemical reaction with hydrogen evolving at the cathode, and driving an exothermic combination reaction at the cathode catalyst to thereby heat up the fuel cell to the temperature required for self-sustaining operation of the fuel cell.

15. The method according to claim 14, which comprises adjusting an air flow rate through said cathode catalyst to assure that the fuel cell voltage does not exceed 0.2 V per cell and to prevent changing electrochemical reaction of hydrogen generation with electrochemical reaction of oxygen reduction on said cathode catalyst;
